(19) United States
(12) Patent Application Publication
(10) Pub. No.: US 2007/0264414 A1
(43) Pub. Date: Nov. 15, 2007

(54) Refrigerated, Developed, Chemically Leavened Dough Compositions Comprising Concentrated Protein Ingredient

(76) Inventors: Tonya C. Schoenfuss, Buffalo, MN (US); Liza B. Levin, Plymouth, MN (US); Jeffrey L. Casper, Minneapolis, MN (US); Alan A. Oppenheimer, Savage, MN (US)

Correspondence Address: GENERAL MILLS, INC., P.O. BOX 1113, MINNEAPOLIS, MN, 55440, US

(21) Appl. No.: 11/576,766

(22) PCT Filed: Aug. 22, 2005
(86) PCT No.: PCT/US05/29895

§ 371 Date: Apr. 5, 2007

Related U.S. Application Data
(60) Provisional application No. 60/618,614, filed on Oct. 14, 2004.
(60) Provisional application No. 60/618,613, filed on Oct. 14, 2004.

(51) Int. Cl. A21D 2/00; A23B 9/00

(52) U.S. Cl. 426/622; 426/392

(57) ABSTRACT

Described are chemically-leavened, developed dough compositions and related methods embodiments of which may include or more of: an elevated level of protein, a concentrated protein ingredient, desired rheology, and desired leavening properties.

### FIELD OF THE INVENTION

The invention relates to chemically-leavened, developed, dough compositions and related methods and products.

### BACKGROUND

Dough products are prepared commercially to be sold as packaged, storage-stable products. Many packaged dough products can be stored at refrigerated or frozen conditions and cooked (e.g., baked) by removing the packaged dough from storage and cooking the dough with little or no additional preparation. Refrigerator stable dough products can be very desirable to consumers because of their convenience.

A variety of dough products are sold commercially as being refrigerator stable. Examples include doughs sometimes referred to in the baking arts as “undeveloped doughs” such as cookies, cakes, biscuits, scones, and batters; other examples are “developed” doughs such as breads and bread-like products including French bread, white or whole wheat bread, bread sticks, bread rolls, pizza dough, cinnamon rolls, raised donuts, and other products having developed dough properties.

Developed doughs are prepared to leaven and increase the size and decrease the density of the cooked (e.g., baked) dough product. Leavening can be caused, for example, by the action of yeast or by the action of chemical ingredients (“chemical leavening agents”) that react to produce a leavening gas. Leavening can take place either before or during baking. Many refrigerator stable developed dough products include chemical leavening agents, and are allowed to proof before they are packaged, during storage, or during baking.

Dough products are prepared by combining ingredients that may include water, flour, leavening agent such as yeast or chemical agents, among others. The ingredients are combined and processed together to achieve desired properties in a raw or cooked dough, such as desired taste, aroma, texture, color, storage stability, and leavening and rheological properties that result in one or more of these. Rheological and mechanical properties of a raw dough such as strength, elasticity, and gas-holding capacity can affect properties such as the ability of a dough to expand during baking.

In the dough and bread-making arts there is ongoing need for new and improved dough compositions based on product quality, cost, or convenience. In one specific respect, consumers desire convenience of use. Doughs that can be stored for extended periods of time and used at-will are appreciated by consumers. Also appreciated are dough products that do not require a substantial amount of time or effort to prepare following removal from storage.

### SUMMARY

The invention relates to developed, chemically-leavened dough compositions and dough products. The dough may contain a concentrated protein ingredient, an elevated overall protein level, or both. It has been discovered that the use of relatively high amounts of protein in a developed, refrigerated, chemically-leavened dough, such as by including a concentrated protein ingredient in the dough formulation, can result in increased leavening upon cooking. Dough compositions described herein may be capable of being cooked to a specific volume that is at least 5 times raw specific volume. Exemplary baked specific volumes that can be achieved may be in excess of 4.5 cubic centimeters per gram (cc/g), e.g., greater than 5 or 6 cc/g, or more, up to 8 cc/g, e.g., from dough compositions having a raw specific volume below 2. Exemplary doughs can also be refrigerator stable and may be partially pre-proofed.

Exemplary dough compositions of the invention can be baked to desirably high specific volumes compared to other formulations of refrigerated, chemically-leavened, developed dough compositions that are not prepared to include protein and concentrated protein ingredients as described herein. The baked specific volumes can be detected by direct observation and measurement upon baking a dough of the invention. Alternately, the ability of a dough to exhibit leavening properties as described herein may result from distinct rheology properties of the dough that can affect leavening properties of the dough during baking. Such rheology properties may correlate with improved leavening properties of a refrigerated, chemically-leavened, developed dough of the invention formulated to include protein or concentrated protein ingredient as described herein, and may be measurable using standard or non-standard rheology techniques and equipment possibly including tests such as a creep deformation test, a stress-relaxation test, or a similar test.

Doughs of the invention can be formulated to include a reduced amount of flour compared to standard developed, chemically-leavened, refrigerated doughs. Standard flours used to prepare doughs include standard white and wheat flours that contain conventional proteins and starches. While these proteins and starches can be useful for various doughs, they may not provide optimal properties for specific types of commercial doughs. According to embodiments of the invention, the amount of standard flour used in a chemically-leavened, developed dough formulation can be reduced relative to certain past chemically-leavened, developed, refrigerated dough formulations. By removing some flour from the dough, the formulation will include lower amounts of conventional proteins and starches.

Also according to the invention, the amounts of protein (and optionally starch) that are eliminated due to the reduced amount of flour can be replaced by separate protein and (optionally) starch ingredients that may provide improved dough properties compared to the removed protein and (optionally) starch. In other words, the amount of protein and optionally the amount of starch removed from the formulation based on the reduced amount of flour can be back-added to the formulation in the form of a separate concentrated protein ingredient and optional starch ingredient.

The concentrated protein ingredient and the optional starch ingredient can be selected to provide desired properties for the specific dough composition. A replacement protein (i.e., protein that replaces the protein that would have been present due to the flour) can be selected to provide desired mechanical and rheological properties in a raw dough, such as improved gas-holding capacity and expansion properties, allowing for greater expansion of the dough during baking.

Optionally, a desired starch or starch ingredient can be used to replace starch from removed flour. The replacement starch can exhibit improved properties compared to the starch of the standard baking flour, e.g., native wheat starch. An improved property may be improved rheology (e.g., hot viscosity) or lower affinity for water compared to native wheat starch. A lower affinity for water may allow water of the dough to be absorbed by protein (instead of starch), to hydrate the protein and strengthen the dough matrix.

According to various embodiments of the invention, a dough can be chemically leavened and may require reduced amounts of chemical leavening agents compared to other, similar, chemically-leavened, refrigerated, developed doughs. Other embodiments of the invention can include water at an elevated level compared to other, similar, chemically-leavened, refrigerated, developed doughs. Still ether embodiments of the invention relate to the use of specific types of concentrated protein ingredients (i.e., wheat protein isolate) in a chemically-leavened, refrigerated, developed dough.

Dough compositions and products of the invention include finished and un-finished (e.g., in-process) dough compositions such as raw doughs and finished, packaged, or cooked (e.g., baked, fried, etc.) dough products prepared from the unfinished or in-process dough compositions.

The invention also relates to methods of making unfinished, finished, formed, cooked, or in-process dough compositions. The dough compositions can be prepared generally by any useful method, including straight-dough methods and methods that involve a preferment or a sponge dough composition, continuous methods, etc.

Examples of specific types of dough products or dough pieces include but are not limited to types of doughs sometimes prepared by using a sponge or preferment methods, including bread, breadsticks, boules, baguettes, rolls, buns, pizza crusts, flatbreads, fococcia, bagels, pretzels, croissants, and the like.

In the present description, unless otherwise indicated, percentages are in terms of the total weight of a dough composition.

An aspect of the invention relates to refrigerated, developed, chemically-leavened dough compositions that include concentrated protein ingredient. The doughs have a raw specific volume in the range from 1.0 to 2.0 cubic centimeters per gram and are capable of being cooked to a specific volume of at least 4.5 cubic centimeters per gram.

In another aspect, the invention relates to a refrigerated, developed, dough composition that includes less than 50 weight percent flour, and concentrated protein ingredient. The total amount of protein in the flour and concentrated protein ingredient is in the range from about 9 to about 20 weight percent of the total dough composition.

In yet another aspect the invention relates to a refrigerated, developed, dough composition that includes less than 50 weight percent flour, and wheat protein isolate.

### DETAILED DESCRIPTION

Dough compositions of the invention include chemically-leavenable, developed, dough compositions. Developed doughs are generally understood to include doughs that have a developed gluten matrix structure; a stiff, elastic rheology; and that are capable of forming a matrix of relatively elastic bubbles or cells that hold a leavening gas while the dough expands, leavens, or rises, prior to or during cooking (e.g., baking). Features that are sometimes associated with a developed dough, in addition to a stiff, elastic rheology, include a liquid component content, e.g., water content, that is relatively high; a high protein content; a relatively low fat content; and processing steps that include time to allow the dough ingredients (e.g., protein) to interact and “develop” or strengthen the dough. Developed doughs in general can be yeast-leavened or chemically-leavened, and are normally relatively less dense prior to and after cooking (i.e., on average have a relatively higher specific volume) compared to un-developed doughs. Examples of specific types of doughs that can be considered to be developed doughs include doughs for pizza crust, breads (loaves, dinner rolls, baguettes, bread sticks), raised donuts and sweet rolls, cinnamon rolls, croissants, Danishes, pretzels, etc.

In contrast to developed doughs, doughs generally referred to as un-developed (or “non-developed” or “under developed”) doughs have an un-developed (or less developed) matrix structure resulting in a non-elastic (or less elastic) rheology and, therefore, relatively lower raw and baked specific volumes due to reduced gas retention by the dough. Examples of un-developed types of doughs include cookies, cakes, cake donuts, muffins, and other batter-type doughs such as brownies, biscuits, etc.

Chemically-leavened (or “chemically-leavenable”) dough compositions include dough compositions that leaven to a substantial extent by the action of chemical ingredients that react to produce a leavening gas. Typically the ingredients include a basic chemical leavening agent and an acidic chemical leavening agent, the two of which react to produce carbon dioxide which, when retained by the dough matrix, causes the dough to expand. Chemically-leavened doughs can be contrasted to dough formulations that are substantially leavened due to the action of yeast as a leavening agent, i.e., by metabolic action of yeast on a substrate to produce gaseous carbon dioxide. While doughs of the invention can include yeast, e.g., as a flavoring agent or as a leavening agent, doughs of the invention are leavened mostly by the action of gases that are not produced by yeast, and exemplary dough compositions of the invention do not include and can specifically exclude yeast as a leavening agent.

Chemically-leavenable, developed dough compositions can be prepared using ingredients and methods generally known in the dough and bread-making arts, typically including combining ingredients that include flour, a liquid component such as oil or water, a chemical leavening system (e.g., an acidic agent and a basic agent), and optional ingredients such as shortening, salt, sweeteners, dairy products, egg products, processing aids, emulsifiers, dough conditioners, yeast, flavorings, and the like.

Acidic chemical leavening agents are generally known in the dough and bread-making arts for use with chemically-leavened doughs. Examples include sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), glucono-delta-lactate (GDL), as well as a variety of others. Commercially available acidic chemical leavening agents include those sold under the trade names: Levn-Lite® (SALP), Pan-O-Lite® (SALP+MCP), STABIL-9® (SALP+AMCP), PY-RAN® (AMCP), and HT® MCP (MCP).

Useful basic chemical leavening agents are generally known in the dough and baking arts, and include soda, i.e., sodium bicarbonate (NaHCO₃), potassium bicarbonate (KHCO₃), ammonium bicarbonate (NH₄HCO₃), etc. These and similar types of basic Chemical leavening agent are generally soluble in an aqueous phase of a dough composition at processing or refrigerated storage temperature.

Optionally, if necessary or desired to control the amount or timing of proofing that occurs in the packaged dough composition, a dough composition can include an encapsulated acidic or basic chemical leavening agent. Discussions of encapsulated leavening agents are included in Assignee's copending U.S. patent application Ser. No. 09/945,204, filed Aug. 31, 2001, entitled “Chemically-Leavenable Doughs and Related Methods,” and in U.S. Pat. No. 6,261,613, the entire disclosures of both of which are incorporated herein by reference. Encapsulated particles containing chemical leavening agents are commercially available and can be prepared by methods known in the baking and encapsulation arts, such as by preparing enrobed particles by use of a fluidized bed. With respect to encapsulated chemical leavening agents, the amount of a chemical leavening agent is described in terms of the active chemical leavening agent not including the amount of any encapsulating agent.

Useful amounts of acidic and basic chemical leavening agents can be amounts that allow the acidic agent to neutralize a desired amount of basic agent, e.g., an amount of acidic agent that is stoichiometric to the amount of basic agent. The exact amount of acidic agent and basic agent can be dependent on the particular chemical leavening system and the particular acid and base that are used. A typical amount of acidic agent such as SALP may be in the range from about 0.1 to about 2 weight percent, e.g., an amount within the range from about 0.2 to about 1.5 weight percent acidic agent based on the total weight of the dough composition.

The amount of a basic chemical leavening agent can be sufficient to react with the acidic chemical leavening agent to release a desired amount of gas for leavening, thereby causing a desired degree of expansion of the dough product. Exemplary amounts of a basic chemical leavening agent (not including the weight of barrier material) may be in the range from about 0.25 to about 2.5 weight percent of the total composition.

A “concentrated protein ingredient” as used according to the present description includes a non-flour dough ingredient that contains a substantial concentration of protein such as gluten or gluten mimetic. A concentrated protein ingredient can be derived from wheat, e.g., in the form of a wheat protein isolate. Other concentrated protein ingredients can be non-wheat ingredients. Such ingredients, including those presently known in the baking arts or developed in the future, include a useful concentration of a protein such as gluten and can be added to the dough composition to improve gas-holding capacity of the dough matrix as described herein.

Non-gluten proteins that may be useful in a concentrated protein ingredient may include proteins such as albumen; casein, casienates; milk proteins such as whey protein, modified whey protein; soy protein; modified soy protein; legume proteins; protein isolates; and the like, any of which may be used alone or in combination with gluten. Certain concentrated protein ingredients can include protein (e.g., gluten) at a concentration of at least 25 or 50 weight percent protein based on the total weight of the concentrated protein ingredient, e.g., at least 75 weight percent protein based on total weight of the concentrated protein ingredient. While dough compositions of the invention include wheat flour, and wheat flours can include gluten, standard wheat flours (including high gluten wheat flour) often used in dough compositions are not considered “concentrated protein ingredients” for purposes of this description. Still, as used here, the term “total protein” in a dough composition includes amounts of protein that are part of a concentrated protein ingredient, plus amounts of protein that are present due to a wheat flour ingredient (e.g., a high gluten flour).

Vital wheat gluten is an example of a concentrated protein ingredient (here, a “concentrated gluten ingredient”), and normally is an ingredient in the form of a protein powder having the ability to reconstitute rapidly in water to give a homogenous, viscoelastic, coherent mass with similar properties as the native flour protein would possess when washed out in the form of wet gluten. Starch and bran normally present in a wheat flour have been removed from this ingredient. The typical commercial vital wheat concentrated protein ingredient can contain from 75 to 80 percent by weight total protein (of which about 80 percent is gluten in the form of either glutenin or gliadin) 10 percent by weight residual starch, and 5 percent by weight lipid (all dry weight basis), with the remainder being minerals, fiber, and other impurities. Moisture content is typically from 8 to 9 percent based on weight, not normally in excess of 10 percent by weight.

Wheat protein isolate is another example of a concentrated protein ingredient, a purified form of gluten, normally in the form of a dry powder prepared by removing starch from wheat flour and drying the remaining protein fraction. In general, wheat protein isolate ingredients are commercially available having a somewhat higher concentration of protein compared to vital wheat gluten ingredients, such as an amount of protein that is 90 percent by weight, e.g., 95 percent by weight, based on the total weight of the wheat protein isolate ingredient. Examples of commercially available wheat protein isolate ingredients include wheat protein isolate products available under the trade designations ARISE, including ARISE 8000, from Midwest Grain Products of Atchison Kans.

According to the invention, concentrated protein can be included as an amount of a dough composition that, in combination with other features and ingredients of the dough composition as described, results in a dough having one or more of the dough properties described herein such as total protein content or leavening properties.

Concentrated protein ingredient can be included in an amount that provides an amount of total protein in a chemically-leavened, developed dough composition in the range from 9 to 20 weight percent protein, including protein that is contributed by the flour and protein that is contributed by the concentrated protein ingredient.

To achieve a desired level of total protein, exemplary amounts of concentrated protein (on a dry basis) can be in the range from 4 to 15 weight percent, e.g., from 5 to 12 weight percent concentrated protein, based on the total weight of a dough composition. For the present description, amounts of concentrated protein included in a dough composition refers to the amount of protein included in the dough composition as part of a concentrated protein ingredient, i.e., on dry basis and not including any water or other components such as starch or bran, that are present in a concentrated protein ingredient.

Concentrated protein may be added to ingredients of a dough composition at any useful stage of preparing a final dough composition, such as by combining a concentrated protein ingredient with other ingredients to produce a dough composition or a preferment dough composition, by combining a concentrated protein ingredient with a previously prepared preferment dough composition that has been rested to allow yeast in the preferment dough composition to ferment, or otherwise. See, for example, Applicants' copending U.S. provisional patent application Nos. 60/618,614, filed Oct. 14, 2004, entitled “DOUGH COMPOSITIONS AND RELATED METHODS, INVOLVING HIGH-GLUTEN CONTENT,” and 60/618,613, filed Oct. 14, 2004, entitled “HIGH EXPANSION FROZEN DOUGH COMPOSITIONS AND METHODS,” the entire disclosures of which are incorporated herein by reference.

A dough composition of the invention may include starch having relatively low, high-temperature viscosity (“hot viscosity”). It has been found that dough compositions that include a starch that exhibits this type of viscosity, in combination with an elevated level of protein, exhibit desirable or advantageous rheological properties that can result in desired properties upon cooking, such as desired cooked (e.g., baked) specific volume.

A starch having a low, high-temperature viscosity may be a component of a particular type of flour that includes the starch, or the starch may be included as a separate (non-flour) ingredient that contains the starch, e.g., a concentrated amount of the starch. The term “starch ingredient” refers to an ingredient that is not a wheat flour and that contains a concentrated amount of starch. While wheat flours include various types of different starches, the term “starch ingredient” is not meant to include wheat flour ingredients such as whole wheat flour, patent flours, soft wheat flours.

Examples of starch ingredients that include starch having a low, high-temperature viscosity can include hydrophobic starches; high amylopectin starch source; modified corn starch (e.g., crosslinked, hydroxypropylated, or acetylated corn starches such as hydroxypropylated corn starch having a minimal degree of substitution of 2%); amylopectin (e.g., a concentrated amylopectin starch source); modified wheat starch (e.g., hydroxypropylated wheat starch, oxidized wheat starch, etc.); and combinations thereof. An example of a type of flour that includes starch having a low high-temperature viscosity is amylopectin found in waxy wheat flour, e.g., full waxy wheat (hard spring or hard winter) flour.

A high-temperature viscosity or “hot viscosity” of a starch refers viscosity measured using a Rapid Visco Amalyzer (RVA). Starch ingredients and starches having a low, high-temperature viscosity are described in Applicants' copending patent application Ser. Nos. 60/618,614, filed Oct. 14, 2004, entitled “DOUGH COMPOSITIONS AND RELATED METHODS, INVOLVING HIGH-GLUTEN CONTENT,” and 60/618,613, filed Oct. 14, 2004, entitled “HIGH EXPANSION FROZEN DOUGH COMPOSITIONS AND METHODS.”

Exemplary starches that exhibit a low, high-temperature viscosity can be identified as starches that exhibit a desirable peak viscosity when measured using AACC method 76-21, such as a peak viscosity that is below or substantially below the peak viscosity for native wheat starch (about 7225 cP). Exemplary starch ingredients exhibiting low high-temperature viscosity (e.g., modified corn starch, modified wheat starch) can exhibit a peak viscosity no greater than 5000 centipoise (cP), e.g., below 3000 cP, and even below 1500 cP or 500 cP, when measured using AACC method 76-21. Exemplary starch ingredients exhibiting low high-temperature viscosity (e.g., modified corn starch, modified wheat starch) can exhibit a peak viscosity that occurs in less than 3 minutes, e.g., in less than 2.5 minutes, when measured using AACC method 76-21.

A starch having a low, high temperature viscosity, if included in a dough composition, can be included by any mode, for example by being present as a component of any dough ingredient such as a type of wheat flour that includes the starch, a non-wheat flour that includes the starch, or any non-flour starch ingredient. Starch that exhibits a low high-temperature viscosity may be added to a dough composition at any useful stage of preparation, such as by combining such a starch (e.g., in the form of a wheat flour or a non-wheat flour starch ingredient) with other ingredients in a straight-dough method or to produce a preferment dough composition, or by combining such a starch (e.g., in the form of a wheat flour or starch ingredient) with a preferment dough composition as an additional dough ingredient after the preferment dough composition has been rested, etc.

An amount of starch having a relatively low high-temperature viscosity can be included in a dough composition in an amount that, in a dough composition having other ingredients and features as described herein, results in desired or improved leavening properties as described. The particular amount of such a starch included in any specific dough composition (if any at all) can depend on factors such as the type of dough product, the desired rheology of a dough matrix, desired leavening properties of the dough during processing and cooking, and types and amounts of other dough ingredients. An exemplary range of amounts of a starch ingredient that contains starch having a relatively low high-temperature viscosity, can be from 0 up to 10 weight percent of such a starch based on the total weight of a dough composition, e.g., from 0.1 to 5 weight percent starch having a relatively low high-temperature viscosity based on the total weight of the dough composition. This includes starch having a relatively low high-temperature viscosity that may be present as a component of any ingredient of the dough composition, including flour (e.g., waxy wheat flour), a starch ingredient (concentrated amylopectin, a modified corn starch or a modified wheat starch, etc.), or another ingredient, that contains starch having a relatively low high-temperature viscosity.

Flour useful in a dough composition can be any suitable flour or combination of flours, such as wheat flour that may be hard wheat winter or spring flour, with protein ranges of from about 10 weight percent to about 16 weight percent protein, based on the weight of the flour. A high protein flour (containing between about 12 and about 16 weight percent protein) may be useful, as can be a flour that contains starch having a relatively low high-temperature viscosity (e.g., amylopectin), such as a partial or full waxy wheat flour.

The amount of flour can be any useful amount, and can be an amount that is reduced or relatively low for a developed, chemically-leavened, refrigerated dough. For example, the amount of flour may be below 50 weight percent flour based on total weight of a dough, e.g., from 30 to less than 50 weight percent, such as from 40 to less than 50 weight percent. The formulation can include a concentrated protein ingredient to provide protein to replace protein due to an optionally reduced amount of protein cause by a reduced amount of flour. Optionally, the formulation may include a starch ingredient to provide additional starch, also as replacements for a reduced amount of starch caused by a reduced amount of flour.

Optionally a chemically-leavened dough of the invention may include an amount of yeast, either for flavoring or for an added degree of leavening. Still, yeast is not required and may be excluded completely if desired.

The dough composition can also include one or more liquid components. Examples of liquid components include water, milk, eggs, and oil, or any combination of these. Water may be added during processing in the form of ice, to control the dough temperature in process; the amount of any such water used is included in the amount of liquid components. The amount of liquid components included in any particular dough composition can depend on a variety of factors including the desired moisture content of the dough composition. Typically, liquids can be present in a dough composition in an amount of from 30 weight percent to 40 weight percent based on total weight of a dough composition.

The dough composition can optionally include fat ingredients such as oils and shortenings. Examples of suitable oils include soybean oil, corn oil, canola oil, sunflower oil, and other vegetable oils. Examples of suitable shortenings include animal fats and hydrogenated vegetable oils.

The dough composition can optionally include various other liquid or dry ingredients, as will be understood, such as egg products or dairy products, e.g., milk, buttermilk, or other milk products, in either dried or liquid forms. Alternatively, milk substitutes such as soy milk may be used. Alternately or in addition, the dough composition can optionally include one or more sweeteners, either natural or artificial, liquid or dry; salt, such as sodium chloride and/or potassium chloride; whey; malt; yeast extract; inactivated yeast; spices; vanilla; natural and artificial flavors; or particulates such as raisins, currants, fruit pieces, nuts, seeds, vegetable pieces, and the like, in suitable amounts.

A final dough composition (prepared by any method) may include, for example, ingredients in the following amounts: flour in an amount between about 30 percent to less than 50 percent by weight flour; water in an amount between 20 and about 40 weight percent, e.g., from 30 to 40 weight percent water; concentrated protein in the range from 4 to 15 weight percent, e.g., from 5 to 12 weight percent concentrated protein (from a concentrated protein ingredient); and total protein (from flour and concentrated protein ingredient) of from 9 to 20 percent by weight. Other ingredients such as flavorings, salt, and additives and preservatives can also be included as desired.

| | Weight percent based |
|---|---|
| | on weight of total composition |
| Water | 20 to 40 |
| Chemical leavening agent | 0.5 to 4.5 |
| (total acidic agent and basic agent) | |
| Flour | 40 to less than 50 |
| Concentrated protein | 5 to 12 |
| starch ingredient -- having a low | 0 to 10 |
| “high-temperature viscosity” | |
| Total protein --- calculated as total | 9 to 20, e.g., 10 to 15 |
| amount of protein contained in flour | |
| and concentrated protein ingredient | |

A dough composition of the invention can be formed in any suitable manner consistent with the present description, such as by steps included in methods generally understood and referred to as “sponge” or “preferment” methods, as well as methods referred to as “straight-dough” methods, continuous methods, etc.

Dough ingredients can be prepared into an unproofed dough (e.g., having a raw specific volume in the range from 0.9 to 1.1 cubic centimeters per gram) that is packaged and sold for sale as a refrigerated dough product. The dough may be sized, portioned, and shaped as desired for packaging and sale. Conventional packaging configurations may be used such as pressurized or non-pressurized cans, pouches, chubs, or other packaging configurations used with refrigerated dough products. As a specific example, multiple dough pieces may be packaged within a flexible package such as a chub or pouch, optionally including a plastic or rigid tray, and wherein the package is designed to exhibit a pressure that is approximately atmospheric pressure during refrigerated storage. Alternately, dough or dough pieces may be packaged in a pressurized container such as a can or canister that becomes pressurized upon expansion of the dough within the container to a pressure, typically to a pressure that is below about 20 pounds per square inch (gauge).

An unproofed dough composition may become proofed or partially-proofed during refrigerated storage based on the action of chemical leavening agents, to a raw specific volume in the range from 1.1 cc/g to about 2 cc/g, such as from 1.1 to 1.5 cc/g. The packaged dough composition can be refrigerator stable, meaning that the packaged dough can be stored at refrigerated conditions (e.g., a temperature in the range from 35 to 40 degrees Fahrenheit) for an extended period of time, e.g., up to or exceeding 4, 6, 8, or 12 weeks, and can then be cooked (e.g., baked) to produce a cooked dough product having aesthetic, organoleptic, and physical properties that would be expected of a cooked developed dough product. A specific volume of the cooked dough may be at least 4.5 cc/g, 5 cc/g, or 6 cc/g, and may be up to 8 cc/g.

### EXAMPLE

| | example 1 | example 2 | example 3 |
|---|---|---|---|
| Ingredients | % | % | % |
| Water | 33.2 | 33.2 | 33.7 |
| Fat | 2.900 | 2.900 | 2.900 |
| Flour | 48.5 | 46.9 | 44 |
| Wheat Protein Isolate | 8 | 0 | 8 |
| VW Gluten | 0 | 9.6 | 0 |
| Modified Starch | 0 | 0 | 4 |
| Sucrose | 2.000 | 2.000 | 2.000 |
| Dextrose | 2.000 | 2.000 | 2.000 |
| Salt | 1.500 | 1.500 | 1.500 |
| GDL | 1.330 | 1.330 | 1.330 |
| Soda | 0.600 | 0.600 | 0.600 |
| Total | 100.0 | 100.0 | 100.0 |

1. A refrigerated, developed, chemically-leavened dough composition comprising wheat protein isolate, the dough having a raw specific volume in the range from 1.0 to 2.0 cubic centimeters per gram and being capable of being cooked to a specific volume of at least 4.5 cubic centimeters per gram.

2. The dough composition of claim 1, capable of being baked to a specific volume in the range from 4.5 to 8 cubic centimeters per gram.

3. The dough of claim 1 comprising flour and concentrated protein ingredient, wherein the total amount of protein in the flour and concentrated protein ingredient is in the range from about 9 to about 20 weight percent of the total dough composition.

4. The dough of claim 1 comprising
at least 30 and less than 50 weight percent flour,
from 4 to 15 weight percent wheat protein isolate,
from 0.1 to 2 parts by weight acidic chemical leavening agent, and
from 0.2 to 2.5 parts by weigh basic chemical leavening agent.

5. The dough of claim 1 wherein the wheat protein isolate comprises at least 90 percent protein by weight.

6. A refrigerated, developed, chemically-leavened dough composition comprising
less than 50 weight percent flour, and
wheat protein isolate,
wherein the total amount of protein in the flour and concentrated protein ingredient is in the range from about 9 to about 20 weight percent of the total dough composition.

7. The dough composition of claim 6 wherein the dough composition is a chemically-leavened dough composition comprising
20 to 40 weight percent water,
0.5 to 4.5 weight percent total acidic and basic chemical leavening agent,
30 to less than 50 weight percent flour, and
4 to 15 weight percent wheat protein isolate.

8. The dough composition of claim 6 further comprising starch having a low, high temperature viscosity.

9. The dough of claim 6 wherein the dough is a chemically-leavened dough composition comprising
from 0.1 to 2 parts by weight acidic chemical leavening agent and
from 0.2 to 2.5 parts by weigh basic chemical leavening agent.

10. The dough of claim 6 wherein the wheat protein isolate comprises at least 90 percent protein by weight, and mixtures thereof.

11. The dough of claim 6 comprising 4 to 15 weight percent wheat protein isolate.

12. The dough of claim 6 exhibiting a raw specific volume in the range from 0.9 to 1.5 cubic centimeters per gram.

13. The dough of claim 12 being capable of being baked to a specific volume of at least 4.5 cubic centimeters per gram.

14. A refrigerated, developed, chemically-leavened dough composition comprising
less than 50 weight percent flour, and
4 to 15 weight percent wheat protein isolate.

15. The dough of claim 14 comprising wheat protein isolate containing at least 90 weight percent protein.

16. The dough of claim 14 exhibiting a raw specific volume in the range from 0.9 to 2.0 cubic centimeters per gram.

17. The dough of claim 16 being capable of being baked to a specific volume in the range from 4.5 to 8 cubic centimeters per gram.

18. A method of preparing a developed, chemically-leavened dough composition, the method comprising
preparing a dough composition according to claim 1,
placing the dough composition in a package,
storing the packaged dough composition at refrigerated conditions, and
cooking the dough composition.

19. A method of preparing a developed, chemically-leavened dough composition, the method comprising
preparing a dough composition according to claim 6,
placing the dough composition in a package,
storing the packaged dough composition at refrigerated conditions, and
cooking the dough composition.

20. A method of preparing a developed, chemically-leavened dough composition, the method comprising
preparing a dough composition according to claim 14,
placing the dough composition in a package,
storing the packaged dough composition at refrigerated conditions, and
cooking the dough composition.
